(19) United States
(12) Patent Application Publication
(10) Pub. No.: US 2008/0018426 A1
(43) Pub. Date: Jan. 24, 2008

(54) REMOTE CONTROLLED POWER SWITCH SYSTEM

(76) Inventor: Jeng-Fuh Liu, Taipei City (TW)

Correspondence Address: MADSON & AUSTIN, 15 WEST SOUTH TEMPLE, SUITE 900, SALT LAKE CITY, UT, 84101, US

(21) Appl. No.: 11/457,995

(22) Filed: Jul. 17, 2006

(51) Int. Cl. G05B 23/02

(52) U.S. Cl. 340/3.9; 340/3.7; 340/825.72; 307/129

(57) ABSTRACT

A remote controlled power switch system includes a transmitter (10) having selection elements and emitting different controlling signals each having a predetermined frequency corresponding to different responses of the selection elements; and a number of receivers (11, 12, 13) each adapted to switch an ON/OFF state of an electrical load under control of the corresponding controlling signal transmitted from the transmitter. The switched receiver transmits a feedback signal to the transmitter after receiving the controlling signal. The transmitter has an indicator unit (106) for indicating the receiving of the feedback signal. The indicator unit comprises an LED light (400) for indicating the ON or OFF state of the switched receiver by emitting different color of lights, a number of LED lights (401, 402, 403) for indicating which of the receivers is switched on, or a display (404) for showing a designated number of the switched receiver.

### BACKGROUND OF THE INVENTION

1. Field of the Invention

The present invention relates generally to a power switch system, and more particularly to a remote controlled power switch system that controls an ON/OFF status of a number of electrical loads connected thereto.

2. Description of the Prior Art

In recent years, remote control devices using infrared rays or radio frequency signals have become widespread. Some electrical apparatus have remote control power switches in the apparatus, such as televisions. For such apparatus, a remote control is used for switching its power ON/OFF by sending a controlling signal to the power switch. Some electrical apparatus are not required to have remote control power switches in the apparatus, such as lamps and the like. For such apparatus, it can be connected with a conventional remote controlled power switch that is adapted to receive a controlling signal from a remote control device to turn on/off the electrical apparatus. In this case, the lamp, and the like, which originally is without the remote control function, can be remotely controlled, so as to facilitate users from a distance.

U.S. Pat. No. 5,047,765 discloses a remote controlled power switch system comprising a transmitter, i.e. a remote control device, and a switch module composed of a receiver, a switch control stage connected to the receiver, and a switch circuit connected to the switch control stage. The switch circuit is connected to a load to turn on/off the load in accordance with the controlling signal from the transmitter. When the transmitter emits an ON signal, the load is lit. When the transmitter emits an OFF signal, the load is shut off.

However, the conventional remote controlled power switch system only functions to control one lamp load at one time. As a result, more than one load will need a number of remote controlled devices. Furthermore, operators may acquire whether the lamp load is turned on or off by observing if it is lit. However, when the load is without use of an illuminable element in/on itself, operators cannot determine whether the load is turned on or off by intuition.

Hence, an improved remote controlled power switch system is required to overcome the above-mentioned disadvantages of the prior art.

### BRIEF SUMMARY OF THE INVENTION

An object, therefore, of the present invention is to provide a remote controlled power switch system that controls more than one electrical loads with only one remote control device.

Another object of the present invention is to provide a remote controlled power switch system having a transmitter and a plurality of receivers, wherein the transmitter can be informed whether its transmitting signal arrives at the corresponding receiver.

In order to achieve the above said objects and overcome the above-identified deficiencies in the prior art, the remote controlled power switch system in accordance with the present invention comprises a transmitter having selection elements and emitting different controlling signals each having a predetermined frequency corresponding to different responses of the selection elements; and a plurality of receivers each adapted to switch an ON/OFF state of an electrical load connected thereto under control of the corresponding controlling signal transmitted thereto from the transmitter. The switched receiver responds a feedback signal to the transmitter after it receives the controlling signal. The transmitter comprises an indicator unit for indicating that it receives the feedback signal. The indicator unit comprises an LED light for indicating the ON or OFF state of the switched receiver by emitting different color lights, a plurality of LED lights corresponding to said plurality of receivers, or a display for showing a designated number of the switched receiver.

The remote controlled power switch system in accordance with the present invention is used for controlling an ON/OFF state of an electrical load. The internal circuit of the remote controlled power switch system comprises a transmitter circuit and a receiver circuit. The transmitter circuit has a controlling signal generator circuit for generating a controlling signal, a feedback signal receiving and decoding circuit for receiving and decoding a feedback signal, and an indicator circuit connected to the feedback signal receiving and decoding circuit and generating an indicating signal due to the feedback signal. The receiver circuit has a controlling signal receiving circuit for receiving the controlling signal from the transmitter, a feedback signal generating and encoding circuit connected to the controlling signal receiving circuit for generating and encoding a feedback signal once the controlling signal receiving circuit receives the controlling signal, and an AC power supply switching circuit connected to the controlling signal receiving circuit for change a communication or cutting off state between the AC power supply and the electrical load.

Other objects, advantages and novel features of the invention will become more apparent from the following detailed descriptions of preferred embodiments when taken in conjunction with the accompanying drawings.

### BRIEF DESCRIPTION OF THE DRAWINGS

The present invention may be best understood through the following description with reference to the accompanying drawings, in which:

FIG. 1 is a schematic view showing the principle of a remote controlled power switch system in accordance with the present invention;

FIG. 2 is a perspective view of a receiver of the remote controlled power switch system in accordance with a preferred embodiment of the present invention;

FIG. 3a is a perspective view of a transmitter in accordance with a first embodiment of the present invention;

FIG. 3b is a perspective view of a transmitter in accordance with a second embodiment of the present invention;

FIG. 3c is a perspective view of a transmitter in accordance with a third embodiment of the present invention.

FIG. 4 is a block diagram of the transmitter of the remote controlled power switch system in accordance with the present invention;

FIG. 5 is a block diagram of the receiver of the remote controlled power switch system in accordance with a preferred embodiment of the present invention;

FIG. 6 is a circuit diagram of the transmitter of the remote controlled power switch system in accordance with a preferred embodiment of the present invention; and

FIG. 7 is a circuit diagram of the receiver of the remote controlled power switch system in accordance with a preferred embodiment of the present invention.

FIG. 8 is a schematic view showing an application of the remote controlled power switch system provide with an internet deck in accordance with an embodiment of the present invention.

### DETAILED DESCRIPTION OF THE INVENTION

References will now be made in details to the preferred embodiments of the present invention.

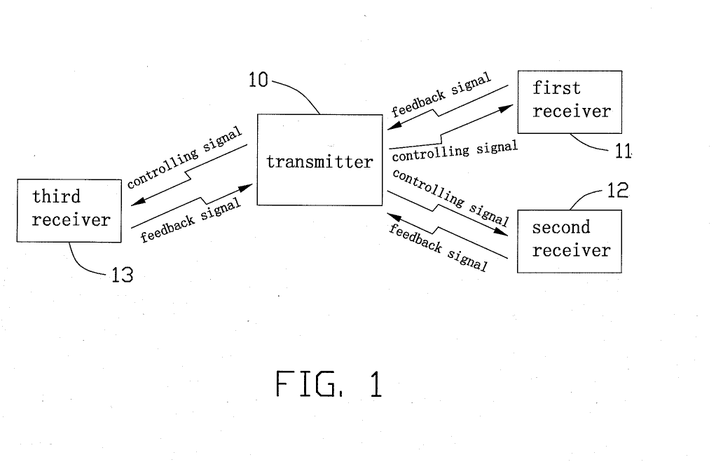

A remote controlled power switch system in accordance with the present invention comprises a transmitter (regarded as a controller) for transmitting controlling signals and at least two receivers for respectively receiving the corresponding controlling signal. Referring to FIG. 1, in a preferred embodiment of the present invention, a first receiver 11, a second receiver 12 and a third receiver 13 are provided to represent the three receivers. Each receiver 11, 12 or 13 is wirelessly connected with a transmitter 10. The transmitter 10 communicates with each of the receivers 11, 12, 13 by transmitting a controlling signal having a predetermined frequency. Each receiver 11, 12, 13 responds to the transmitter 10 with a feedback signal having the same frequency as the corresponding controlling signal emitting thereto.

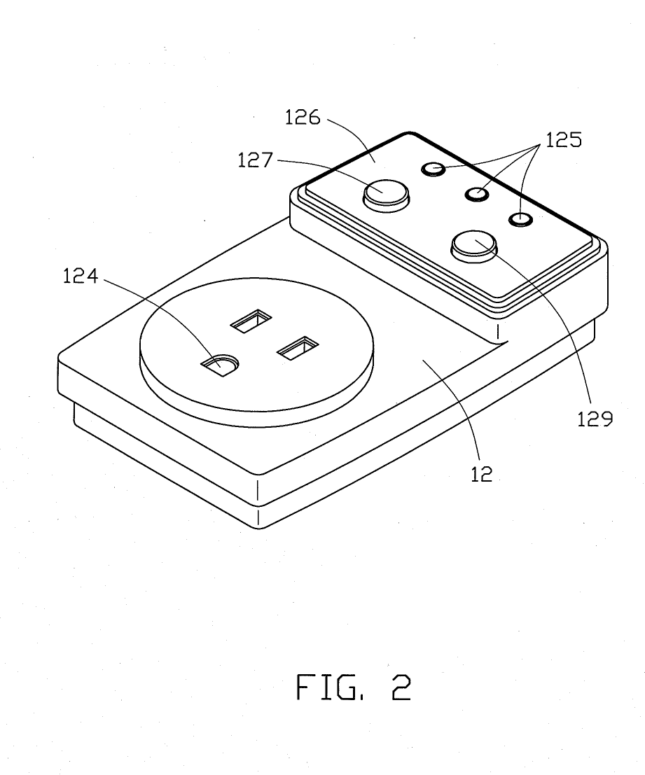

Referring to FIG. 2, while each receiver 11, 12 and 13 has the same configuration, FIG. 2 shows the receiver 12 configuration, for instance. The receiver 12 is shaped as a wall socket having a front face jack 124 to connect with an electrical load (not shown) and a back face plug (not shown) to connect with an AC power supply. The jack 124 and the plug can be of any type, such as two phase or three phase jack and plug. In an embodiment, the receiver 12 has an ON/OFF button 127 and an ON button 129 arranged on a front panel 126 thereof. The ON/OFF button 127 is used for switching the communication and cut off status between the AC power supply and the electrical load connected thereto. The ON button 129 is used for directly conducting the AC power supply to the electrical load connected thereto by one touch. In an embodiment, a plurality of indicating lights 125 (i.e. LEDs) for respectively indicating the different status of the receiver 12, such as an “ON” status indicating that the receiver 12 is turned on (i.e. conductive between the AC power supply and the electrical load), and an “OFF” status indicating that the receiver 12 is turned off (i.e. cutting off between the AC power supply and the electrical load). It is to be noted that, the numbers of the indicating lights 125 and the buttons 127, 129, and the relative functions of the indicating lights 125 and the buttons 127, 129 can be preset according to requirements, which are not limited as the aforementioned description. Additionally, the indicating lights 125 and the buttons 127, 129 can be omitted, which will not affect the usage of the receiver 12.

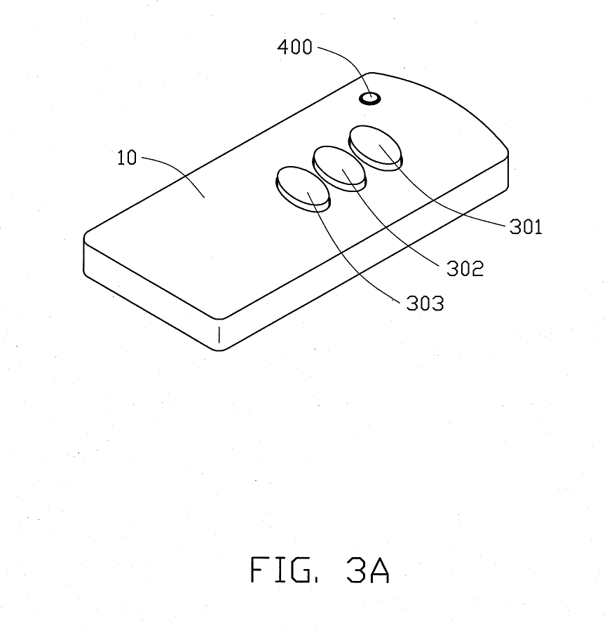

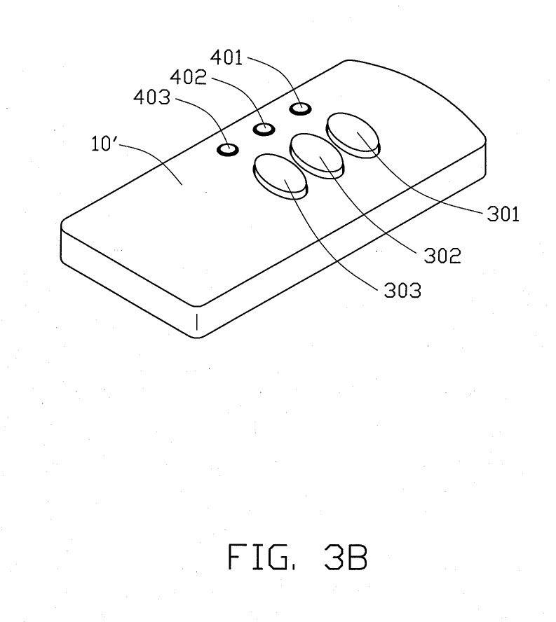

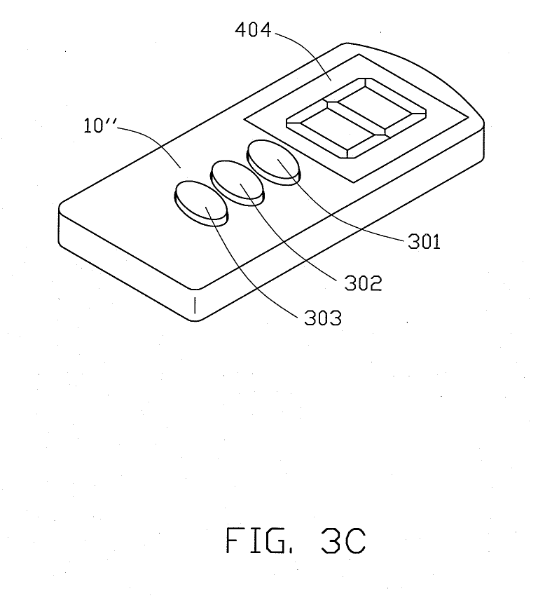

Referring to FIG. 3A, the transmitter 10 in accordance with a first embodiment of the present invention, has a first, a second and a third controlling buttons 301, 302 and 303, and a feedback indicator light 400 disposed on a front panel thereof. The controlling buttons 301, 302 and 303 are used for selecting the receiver to control the receivers 11, 12 and 13. Specially, the first controlling button 301 is corresponding to the first receiver 11, the second controlling button 302 is corresponding to the second receiver 12, and the third controlling button 303 is corresponding to the third receiver 13. The feedback indicator light 400 is provided for indicating whether the transmitter 10 receives the feedback signal from the receiver 11, 12 or 13. The feedback indicator light 400 will be illuminated when the transmitter 10 receives a feedback signal from whatever the first, the second or the third receivers 11, 12 or 13, so as to inform the user the state (ON or OFF) of the receiver 11, 12 or 13. The ON or OFF state is indicated by different colors of the feedback indicator light 400. (details described below)

Referring to FIG. 3B, the transmitter 10′ in accordance with a second embodiment of the present invention, has a first, a second and a third controlling buttons 301, 302 and 303, which are the same as that in the first embodiment, and a first, a second and a third feedback indicator lights 401, 402 and 403 respectively corresponding to the first, second and third controlling buttons 301, 302 and 303. When the first receiver 11 receives the first controlling signal from the transmitter 10′, it will respond a first feedback signal to the transmitter 10′. As a result, the first feedback indicator light 401 is lightened after it receives the first feedback signal. Similarly, when the second receiver 12 receives the second controlling signal from the transmitter 10′, it will respond a second feedback signal to the transmitter 10′. As a result, the second feedback indicator light 402 is lightened after it receives the second feedback signal. When the third receiver 13 receives the third controlling signal from the transmitter 10′, it will respond a third feedback signal to the transmitter 10′. As a result, the third feedback indicator light 403 is lightened after it receives the third feedback signal. Therefore, the user can acquire the status of every receiver 11, 12, 13 by observing the feedback indicator lights 401, 402 and 403.

Referring to FIG. 3C, the transmitter 10″ in accordance with a third embodiment, has a first, a second and a third controlling buttons 301, 302 and 303, which are the same as that in the first embodiment, and a feedback indicator display 404. The feedback indicator display 404 is an LED seven-segment display which is composed of seven LEDs and can display the numbers zero to nine by illuminating different numbers of LEDs in different figure positions representing the numbers zero to nine. Accordingly, the feedback indicator display 404 will display a designated number of “1”, “2” or “3” of the switched (turned on or off) one of the first, second or third receivers 11, 12 or 13. It should be noted that the number, shape, size, type (press switch, tact switch, slide switch, push switch, etc) of the buttons on the transmitter 10″ can be changed corresponding to the actual usage requirement. The feedback indicator display 404 can adopt any type of displays according to the actual requirement, such as a LCD display.

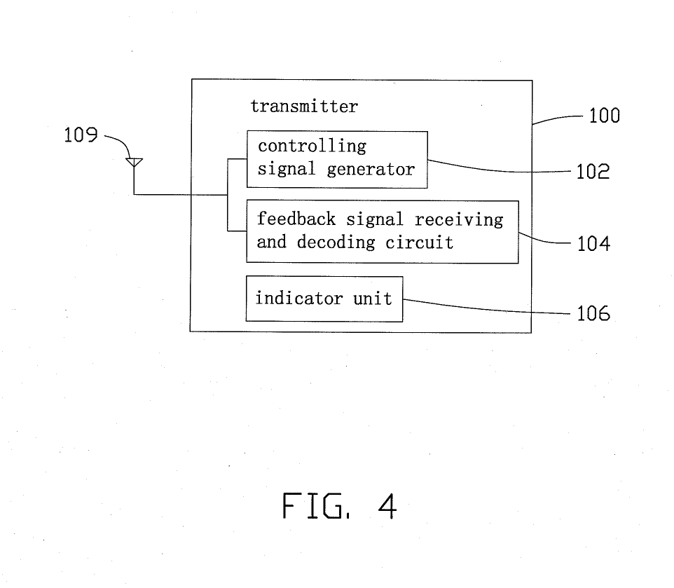

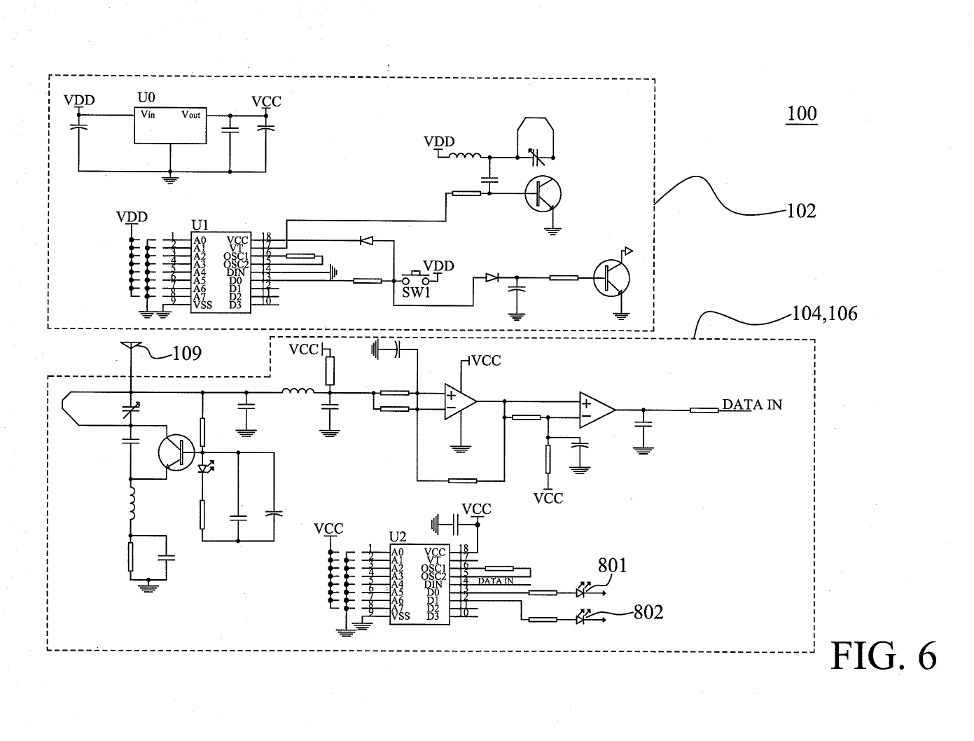

Referring to FIGS. 4 and 6 in combination, FIG. 4 shows a block diagram of the internal circuit 100 of the transmitter 10, and FIG. 6 is the detailed circuit diagram of FIG. 4.

The transmitter circuit 100 comprises a controlling signal generator 102 for generating different controlling signals having different frequencies according to the pressed controlling button 301, 302, 303, and emitting the controlling signals though an antenna 109; a feedback signal receiving and decoding circuit 104 for receiving and decoding the feedback signal responded by the receiver 11, 12, 13; and an indicator unit 106 for providing indication when the feedback signal receiving and decoding circuit 104 receives the feedback signal from the receiver 11, 12, 13, through the antenna 109. The indicator unit 106 should be adapted with the indicator light 400 shown in FIG. 3A in accordance with the first embodiment, the first to third indicator lights 401, 402, 403 shown in FIG. 3B in accordance with the second embodiment, or the indicator display 404 shown in FIG. 3C in accordance with the third embodiment. It is to be noted that, the transmitter 10, 10′, 10″ will provide a denotation through the indicator light 400 (or 401 to 403) or the indicator display 404 once the receiver 11, 12 or 13 is switched and reflects the feedback signal, whatever the receiver is switched to turn on or off.

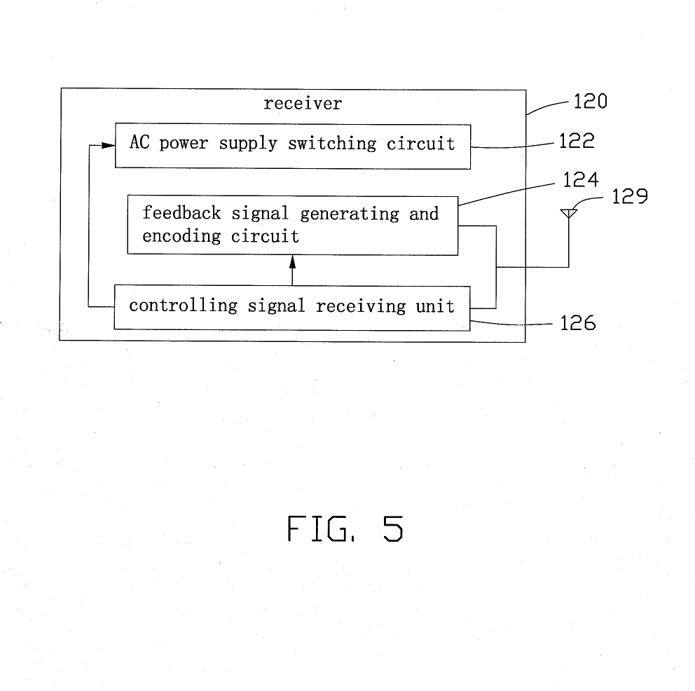

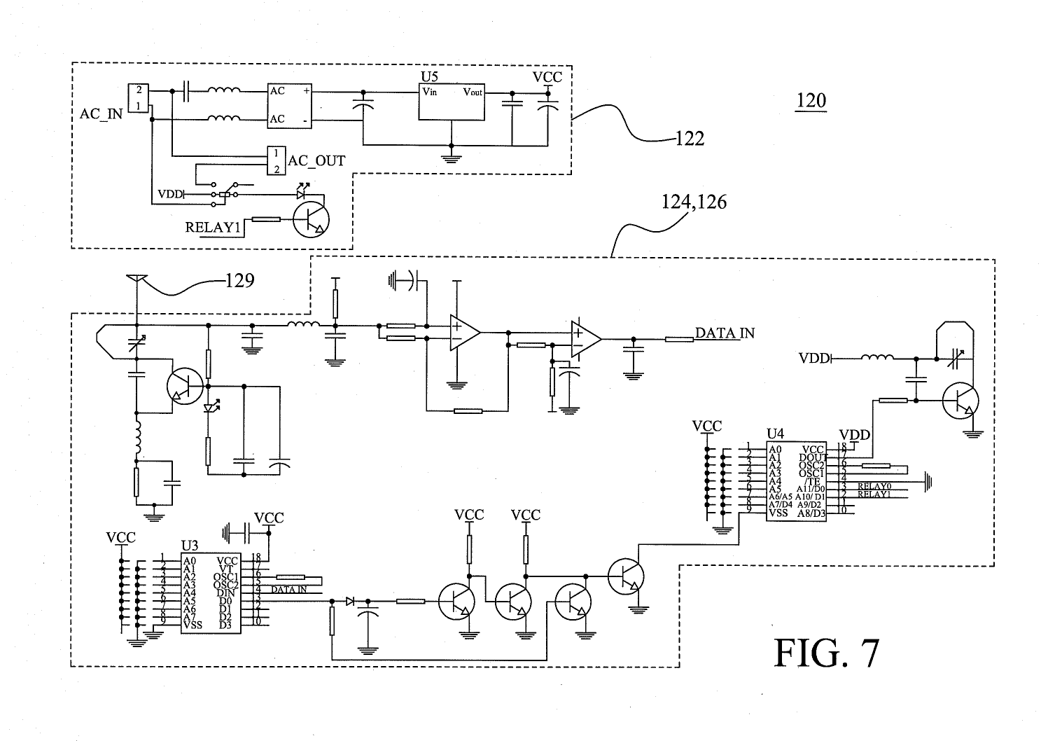

Referring to FIGS. 5 and 7 in combination, FIG. 5 shows a block diagram of the internal circuit 120 of any one of the receivers 11, 12, 13, and FIG. 7 is the detailed circuit diagram of FIG. 5.

The receiver circuit 120 comprises an AC power supply switching circuit 122 for conducting or cutting off the path between the AC power supply and the electrical load; a feedback signal generating and encoding circuit 124 for generating and encoding the feedback signal and transmitting the encoded feedback signal to the transmitter 10 through an antenna 129; and a controlling signal receiving unit 126 for receiving the controlling signal from the transmitter 10 through the antenna 129 and sending a signal to the AC power supply switching circuit 122 to switch the on/off status of the receiver. In other embodiments, the receiver circuit 120 should further comprises an indicating unit (not shown) connecting with the controlling signal receiving unit 126 for supporting the function of the indicating lights 125, if there are.

Jointly referring to FIGS. 6 and 7, when the controlling button 301 is pressed, the corresponding switch SW1 (as shown in FIG. 6) is closed. Accordingly, the first controlling signal having the first frequency is generated in the controlling signal generator 102. Similarly, when the controlling button 302 or 303 is pressed, the corresponding switch (not shown) is closed. Accordingly, the second controlling signal having the second frequency or the third controlling signal having the third frequency is generated. The controlling signals are transmitted through the antenna 109 (shown in FIG. 6) and respectively received by the corresponding receiver 11, 12 or 13 through the antenna 129 (shown in FIG. 7). In the receiver circuit 120, the received controlling signal is sent to the chip U3 from pin 14 and coupled to the AC power supply switching circuit 122 to switch the communication or cutting off status between the terminal AC_IN from which the AC power supply is input and the terminal AC_OUT through which the electrical load is powered. The signal input from pin 14 of U3 is then output to the encoding chip U4 from pin 13 of the chip U3. Then an encoded feedback signal is generated in the chip U4 and output from pin 12. When the feedback signal is received by the receiver circuit 100 through the antenna 109, it will be sent to the chip U2 from pin 14 after RF processing. The feedback signal then is decoded in the chip U2 and output from pin 12 or 13 for driving the LED 801 or 802. If a receiver of the receivers 11, 12, and 13 is turned on by a corresponding controlling signal, the feedback signal from the “ON” receiver will drive the LED 802 to illuminate a first color light (i.e. red light). If a receiver of the receivers 11, 12, and 13 is turned off by a corresponding controlling signal, the feedback signal from the “OFF” receiver will drive the LED 801 to illuminate a second color light. It is to be understood, the indicator unit 106 of the transmitter circuit 100 is not limited to use two LEDs for indicating, and it can be modified in accordance with different requirements and applications of the present invention.

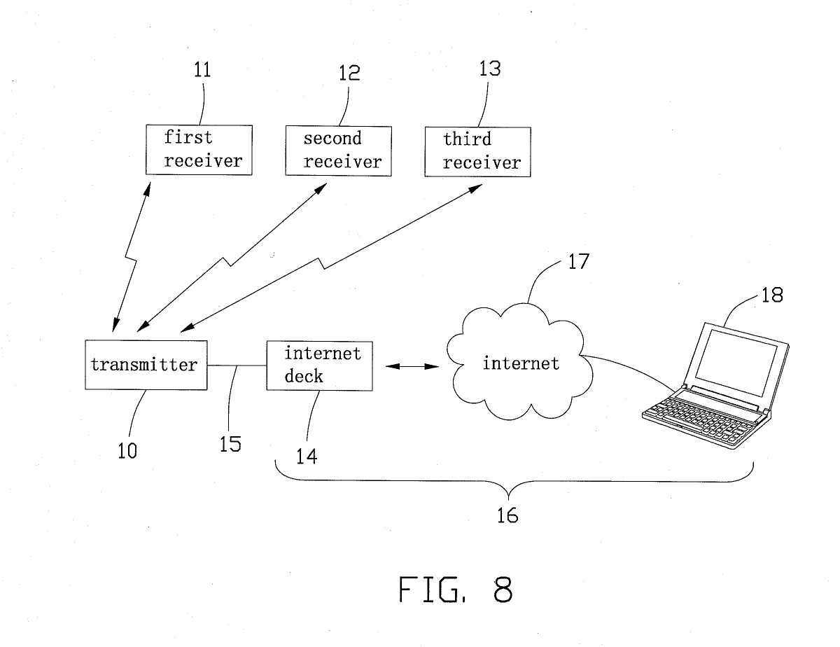

FIG. 8 shows an application of the remote controlled power switch system in a network circumstance in accordance with an embodiment of the present invention. The power switch system in the embodiment has a similar structure to the one aforementioned in the preferred embodiment, the two of which both comprise the transmitter 10 (i.e. the controller), and a plurality of receivers 11, 12, 13 (i.e. the power switches). In this network application, the power switch system is further equipped with an internet deck 14 to the transmitter 10. The internet deck 14 can charge a battery of the transmitter 10 and switch the controlling right from the transmitter 10 to an internet system 16 by a pins connecting interface 15 between the transmitter 10 and the deck 14. The internet deck 14 with a software allows the user to understand the On/Off status of each power switch 11, 12 or 13 and to control any power switch 11, 12 or 13 through the Internet 17 at a remote network terminal 18. The power switches 11, 12 and 13 each sends a feedback signal when it is switched. The feedback signal finally arrives to the network terminal 18 and is displayed on a screen of the network terminal 18 to inform the user the On/Off status of each power switch.

In conclusion, the remote controlled power switch system in accordance with the present invention can control the power switch On/Off either manually through the remote controller 10 or through the Internet 17 with a software if the controller 10 is put on the internet deck 14.

It is to be understood, however, that even though numerous characteristics and advantages of the present invention have been set forth in the foregoing description, together with details of the structure and function of the invention, the disclosure is illustrative only, and changes may be made in detail within the principles of the invention to the full extent indicated by the broad general meaning of the terms in which the appended claims are expressed.

What is claimed is:

1. A remote controlled power switch system, comprising:
a transmitter having selection means and emitting different controlling signals each having a predetermined frequency corresponding to different selections of the selection means; and
a plurality of receivers each adapted to switch an ON/OFF state of an electrical load connected thereto under control of the corresponding controlling signal transmitted thereto from the transmitter;
wherein the switched receiver transmits a feedback signal to the transmitter after it receives the controlling signal.

2. The remote controlled power switch system as claimed in claim 1, wherein the transmitter comprises an indicator unit for indicating that it receives the feedback signal.

3. The remote controlled power switch system as claimed in claim 2, wherein the indicator unit comprises an LED light for indicating the ON or OFF state of the switched receiver by emitting different color lights.

4. The remote controlled power switch system as claimed in claim 2, wherein the indicator unit comprises a plurality of LED lights corresponding to said plurality of receivers.

5. The remote controlled power switch system as claimed in claim 2, wherein the indicator unit comprises a display for showing a designated number of the switched receiver.

6. The remote controlled power switch system as claimed in claim 1, wherein the controlling signals are radio frequency signal having different frequencies.

7. The remote controlled power switch system as claimed in claim 6, wherein the feedback signal has the same frequency as that of the corresponding controlling signal.

8. The remote controlled power switch system as claimed in claim 1, wherein the receivers each is formed as a wall socket having a front jack adapted to connect with the electrical load and a back plug adapted to connect with an AC power supply.

9. A remote controlled power switch system for controlling an ON/OFF state of an electrical load, comprising:
a transmitter having a controlling signal generator circuit for generating a controlling signal, a feedback signal receiving and decoding circuit for receiving and decoding a feedback signal, and an indicator circuit connected to the feedback signal receiving and decoding circuit and generating an indicating signal due to the feedback signal; and
a receiver connected with said electrical load and an AC power supply, having a controlling signal receiving circuit for receiving the controlling signal from the transmitter, a feedback signal generating and encoding circuit connected to the controlling signal receiving circuit for generating and encoding a feedback signal once the controlling signal receiving circuit receives the controlling signal, and an AC power supply switching circuit connected to the controlling signal receiving circuit for change a communication or cutting off state between the AC power supply and the electrical load.

10. The remote controlled power switch system as claimed in claim 9, wherein the indicator circuit has a first and a second LEDs, and said indicating signal generated by the indicator circuit is provided for driving one of the two LEDs to illuminate.

11. The remote controlled power switch system as claimed in claim 10, wherein the indicating signal is provided for driving the first LED to illuminate a first color light which indicates the receiver is turned on, and driving the second LED to illuminate a second color light which indicates the receiver is turned off.

12. The remote controlled power switch system as claimed in claim 9, comprising a plurality of receivers being controlled by the same transmitter, the receivers being controlled with different controlling signals having different frequencies.

13. A remote controlled switch system, comprising:
at least two wall sockets each adapted to connected an electrical load with an AC power supply; and
a remote control device having at least two controlling buttons corresponding to said at least two wall sockets, and comprising an indicator unit, the remote control device generating and sending controlling signals respectively to said at least two wall sockets to switch the wall sockets once the controlling buttons corresponding to the wall sockets are pressed, wherein the wall sockets each reflects a feedback signal to the remote control device once it is switched, and said indicator unit of the remote control device indicates a feedback state of the switched socket.

14. The remote controlled power switch system as claimed in claim 13, wherein the indicator unit is adapted to indicate an ON or OFF state of the switched socket.

15. The remote controlled power switch system as claimed in claim 14, wherein the indicator unit comprises an LED light for emitting multiple color lights to indicate whether the switched socket is turned ON or OFF.

16. The remote controlled power switch system as claimed in claim 13, wherein the indicator unit is adapted to indicate which one of the sockets is switched.

17. The remote controlled power switch system as claimed in claim 13, wherein the indicator unit comprises a seven-segment display to display a designated number of the switched sockets.

18. The remote controlling power switch system as claimed in claim 13, wherein each wall socket has a front jack adapted to connect with the electrical load and a back plug adapted to connect with the AC power supply.

19. A remote controlled power switch system, comprising:
at least two power switches each adapted to connected an electrical load with an AC power supply; and
a controller provided with an internet deck, the internet deck being wirelessly connected with a network terminal through the Internet network and having an authority to switch the controlling right between the controller and the network terminal;
wherein the power switches each sends a feedback signal to the controller which finally arrives to the network terminal when it is switched, and the feedback signal is displayed on the network terminal to inform the user the On/Off status of each power switch.
